(19) United States
(12) Patent Application Publication
(10) Pub. No.: US 2025/0136291 A1
(43) Pub. Date: May 1, 2025

(54) SYSTEM FOR DETECTING SMOKE IN CARGO TRANSPORTED IN A PASSENGER CABIN OF AN AIRCRAFT

(71) Applicant: INFLIGHT INVESTMENTS INC., St-Laurent (CA)

(72) Inventor: George R. SMALLHORN, St-Laurent (CA)

(21) Appl. No.: 18/690,950

(22) PCT Filed: Sep. 13, 2022
(86) PCT No.: PCT/CA2022/051365

§ 371 Date: Mar. 11, 2024

Related U.S. Application Data
(60) Provisional application No. 63/243,440, filed on Sep. 13, 2021.

(51) Int. Cl. B64D 45/00; A62C 3/08; A62C 37/40; B64D 9/00; G08B 17/10

(52) U.S. Cl. CPC B64D 45/00; A62C 3/08; A62C 37/40; B64D 9/003; G08B 17/10; B64D 2045/009

(57) ABSTRACT

A system for detecting smoke in a cargo container in an aircraft cabin is disclosed. The system is exterior to and separate from the cargo container, and may remain in the aircraft cabin when the cargo container is removed. The system comprises a housing having an interface for sealably and releasably coupling to a mounting surface defining an opening in the cargo container. Releasable coupling mechanism couple the housing to the mounting surface. A sensor configured to detect at least one of a concentration of smoke or temperature within an internal volume defined by the cargo container is disposed to fluidly communicate with the internal volume through the opening when the housing is coupled to the mounting surface. A controller receives data from the sensor and when the concentration of smoke or temperature exceeds a prescribed value, an output is generated for communicating an alert.

### TECHNICAL FIELD

The disclosure relates generally to a system for detecting smoke in a cargo container, and more particularly to a system for detecting smoke in a cargo container in a passenger cabin of an aircraft.

### BACKGROUND

A fire or conditions leading to a fire may jeopardize an aircraft's continuing ability to fly safely. Sometimes fire detection systems may be incorporated within cargo containers loaded in an aircraft to alert a flight crew of an impending fire. However, inspection and maintenance of these fire detection systems may be inconvenient and time-consuming for a flight crew since each cargo container may need to be dealt with individually. In addition, inspection and maintenance of these fire detection systems may need to occur outside of an aircraft before the cargo containers are loaded into the aircraft. Improvement is desirable.

### SUMMARY

In an aspect, the disclosure describes a system for detecting smoke in a cargo container in an aircraft cabin. The system may be exterior to and separate from the cargo container, and may remain in the aircraft cabin when the cargo container is removed.

In another aspect, the disclosure describes a system comprising: a housing having an interface for coupling to a mounting surface of a cargo container in an aircraft cabin, the interface comprising a first surface configured to releasably couple and seal to a mounting surface of the cargo container defining an opening; a releasable coupling mechanism for releasably coupling the housing to the mounting surface of the cargo container; a sensor configured to detect at least one of a concentration of smoke or temperature within an internal volume defined by the cargo container, the smoke detector being disposed to fluidly communicate with the internal volume through the opening when the housing is coupled to the mounting surface of the cargo container; and a controller configured to: receive data from the sensor indicative of the at least one of the concentration of smoke or temperature; and when the at least one of the concentration of smoke or temperature exceed a prescribed value, generate a output for communicating an alert.

In an embodiment, the housing defines a first portion of a closed loop flow path, wherein when the interface of the housing is coupled to the mounting surface of the cargo container, internal volume of the cargo container defines a second portion of the closed loop flow path; and where the sensor being disposed along the first portion of the closed loop flow path.

In an embodiment, the system comprises a circulation fan configured to circulate air from the internal volume to the sensor.

In an embodiment, the housing comprises a decompression panel that is configurable between a closed position and an opened position; when the decompression panel is in the closed position, the housing and the decompression panel cover the opening defined by the cargo container preventing air from venting from the internal volume of the cargo container; when the decompression panel is in the opened position, the decompression panel is configured to expose the opening to the cabin to vent air within the cargo container to the cabin; the decompression panel is configured to transition from the closed position to the opened position when a pressure within the cargo container exceeds a pressure within the cabin by a prescribed amount.

In an embodiment, the mounting surface is a mounting plate, and wherein the housing comprises the releasable coupling mechanism to couple to the mounting plate. The releasable coupling mechanism may comprise at least one of hook and clip configured to couple with the mounting plate; a magnet configured to releasably couple the interface to the mounting plate; fasteners; a screw fastener for releasably coupling the interface to the mounting plate; a sliding fastener; a snap-fit fastener; and a clamp.

In an embodiment, the housing comprises a conduit coupled to a fire expellant system, the conduit configured to receive fire expellant from a reservoir.

In an embodiment, the systems comprises a overpressure control valve that is configured to vent air in the internal volume to a location exterior to the cabin when a pressure within the cargo container exceeds a prescribed pressure.

In an embodiment, the housing comprises an equalization valve configured to open allowing fluid communication between the cabin and the internal volume when a pressure within the cargo container is less than a second prescribed pressure and close when the pressure within the cargo container is greater than or equal to the second prescribed pressure.

In an embodiment, the interface comprises a plurality of receptacle sensors configured to signal the controller when the receptacle sensors are positioned on the mounting surface, wherein upon receipt of the signal from the receptacle sensor the controller generates a output configured to cause an second indicator to activate.

In an embodiment, the housing comprising a mounting member configured to couple to one or more brackets of the cabin for supporting one or more overhead bins, wherein the mounting member is configured to secured the housing when stowed.

Embodiments may include combinations of the above features.

In another aspect, the disclosure describes a system for detecting smoke or a temperature in one or more cargo containers in a cabin of an aircraft. The system comprises an air circulation system defining a first portion of a closed loop flow path, when the air circulation system is coupled to a mounting surface of one of the one or more cargo containers, the internal volume of the one cargo container defines a second portion of the closed loop flow path; a smoke detector configured to detect a presence of at least one of smoke or temperature within air circulated through the internal volume defined by the cargo container, the smoke detector being disposed along the first portion of the closed loop flow path; wherein the system is exterior to the cargo container.

In an embodiment, the air circulation system comprises an air circulation fan configured to circulate air within the closed loop flow path, the circulation fan being disposed along the first portion of the closed loop flow path.

In an embodiment, the system comprises the one or more conduits includes a first conduit and a second conduit; the first conduit is configured to supply air to the internal volume of the cargo container through an first opening defined in the cargo container; and the second conduit is configured to receive air from the internal volume of the cargo container through a second opening defined in the cargo container.

In an embodiment, the system comprises a mounting member configured to couple to one or more brackets of the cabin for supporting one or more overhead bins, wherein the mounting member is configured to secured the air circulation system when stowed.

In an embodiment, the air circulation system comprises: an overpressure valve that is configured to open the closed loop flow path to vent air in the closed loop flow path to a location exterior to the cabin when a pressure within the closed loop flow path exceeds a first prescribed pressure.

In an embodiment, the air circulation system comprises an equalization valve configured to open allowing fluid communication between the cabin and the internal volume when a pressure within the closed loop flow path is less than a second prescribed pressure and close when the pressure within the closed loop flow path is greater than or equal to the second prescribed pressure.

In an embodiment, the air circulation system comprises: a receptacle having an interface that is configured for coupling to a mounting surface of the cargo container defining a third opening; wherein the interface is configured to sealably couple to the mounting surface of the cargo container such that smoke detector is in fluid communication with the internal volume of the cargo container.

In an embodiment, the receptacle comprises a decompression panel that is configurable between a closed position and an opened position; when the decompression panel is in the closed position, the receptacle and decompression panel cover the third opening defined by the cargo container and prevent air from venting from the internal volume of the cargo container; when the decompression panel is in the opened position, the decompression panel is configured to expose the third opening to the cabin to vent air within the cargo container to the cabin; the decompression panel is configured to transition from the closed position to the opened position when a pressure within the cargo container exceeds a pressure within the cabin by a prescribed amount.

In an embodiment, the mounting surface is a mounting plate, and wherein the receptacle comprises a releasable coupling mechanism to couple to the mounting plate.

In an embodiment, the system comprises comprising a fire expellant system having: a reservoir for fire expellant; a conduit coupling the reservoir to the air circulation system; a valve to control the flow of fire expellant from the reservoir to the air circulation system, the conduit fluidly communicating with the air circulation system and the internal volume of the cargo container when the valve is in an open position.

In an embodiment, the system comprises a controller configured to: receive data indicative of at least one of a concentration of smoke and/or temperature, within the air circulated through the internal volume defined by the cargo container from the smoke detector; receive data indicative of the position of the cargo container within the aircraft; determine that at least one of the concentration of smoke and/or temperature within the air exceeds a prescribed value; and when the at least one of the concentration of smoke and/or temperature exceed the prescribed value, generate an output configured to cause an indicator to be activated associated with the position of the cargo container in the aircraft. One or more sensors may be provided for determining a status of the one or more cargo containers within the cabin of the aircraft and wherein the controller is configured to receive data from the sensors indicative of the status of at least one of: deployment of a fire expellant to the cargo container; operational status of the smoke detector; one of the one or more air circulation system coupling to the cargo container; and a fan speed of the circulation fan below a prescribed value; wherein the controller is configured to generate an output to cause an indicator to be activated associated with the status and the position of the cargo container in the aircraft. In an embodiment, the controller is configured to receive data from a switch to deploy fire expellant to one of the cargo containers, and to generate a signal to open a valve controlling flow of fire expellant from a reservoir to the cargo container.

In an embodiment, the system comprises the cargo container having a cargo container housing comprising the mounting surface defining the opening to fluidly communicate the internal volume of the cargo container to the housing.

Embodiments may include combinations of the above features.

In another aspect, the disclosure describes a system for detecting the presence of smoke in each of a plurality of cargo containers stored in a cabin of an aircraft, the system comprising: a controller configured to: receive data indicative of at least one of a concentration of smoke and/or temperature within the; receive data indicative of the position of the cargo container within the aircraft; determine that the at least one of the concentration of smoke and/or temperature within the air exceeds a prescribed value; and when the at least one of the concentration of smoke and/or temperature exceed the prescribed value, generate a first output for communicating an alert.

In an embodiment, the controller is exterior to the cargo container.

In an embodiment, the controller is configured to receive data from one or more sensors indicative of the status of at least one of: deployment of a fire expellant to the cargo container; operational status of the smoke detector; receptacle coupling to the cargo container; and a fan speed of the circulation fan below a prescribed value; and wherein the controller is configured to generate an output to cause an indicator to be activated associated with the status and with the position of the cargo container in the aircraft.

Embodiments may include combinations of the above features.

In a further aspect, the disclosure describes an air circulation system comprising: a receptacle for coupling to a cargo container in an aircraft, the receptacle comprising a first surface configured to sealably couple to a mounting surface of the cargo container defining an opening; a first and second conduit configured to define a first portion of a closed loop flow path, the closed loop flow path having a second portion that passes through an internal volume defined by the cargo container; and a circulation fan configured to circulate air within the closed loop flow path, the circulation fan being disposed along the first portion of the closed loop flow path.

Embodiments may include combinations of the above features.

In a further aspect, the disclosure describes a system comprising: a housing having a receptacle for coupling to a cargo container in an aircraft cabin, the receptacle comprising a first surface configured to sealably couple to a mounting surface of the cargo container defining an opening; a sensor configured to detect at least one of a concentration of smoke or temperature within the internal volume defined by the cargo container, the smoke detector being disposed to fluidly communicate with the internal volume; and a controller configured to: receive data from the sensor indicative of the at least one of the concentration of smoke or temperature; and when the at least one of the concentration of smoke or temperature exceed a prescribed value, generate a output for communicating an alert.

Embodiments may include combinations of the above features.

In a further aspect, the disclosure described a cargo container. The cargo container comprises a cargo container housing comprising a mounting surface defining an opening to fluidly communicate an internal volume of the cargo container to the sensors of the air circulation systems described in this disclosure.

Embodiments may include combinations of the above features.

Further details of these and other aspects of the subject matter of this application will be apparent from the detailed description included below and the drawings.

### DESCRIPTION OF THE DRAWINGS

Reference is now made to the accompanying drawings, in which:

FIG. 1 is a top plan view of an exemplary layout of passenger cabin in an aircraft that includes a system for detecting the presence of smoke and/or a temperature in one or more cargo containers restrained within the passenger cabin;

FIG. 2 is a schematic diagram of an exemplary embodiment of the system of FIG. 1;

FIG. 3A is a front view of an example instrument panel that includes a plurality of smoke indicators. FIG. 3B is a fragmentary view of the instrument panel of FIG. 3A;

FIG. 4 is a cross-sectional view of the passenger cabin of FIG. 1 taken along line 4-4 in FIG. 1 showing two cargo containers;

FIG. 5 is a front view of air circulation system that forms part of the system of FIG. 1 that is used for monitoring a presence of smoke in one of the two cargo containers shown in FIG. 4;

FIG. 6A is a perspective of a portion of the cargo container shown in FIG. 5 having an example receptacle releasably coupled to a surface of the cargo container;

FIG. 6B is a perspective view of the receptacle of FIG. 6A having a decompression panel configured in an open position;

FIG. 7A is a perspective view of another example receptacle having a fire expellant conduit and a decompression panel in a closed position;

FIG. 7B is a perspective view of the example receptacle of FIG. 7A showing the decompression panel in an open position;

FIG. 8 illustrates a perspective view of a portion of the passenger cabin of FIG. 1;

FIG. 9 is a front-top perspective view of an example air circulation system that forms part of the system of FIG. 1 that is used for monitoring a presence of smoke in one of the two cargo containers shown in FIG. 4;

FIG. 10 is a bottom view of the example air circulation system of FIG. 9;

FIG. 11 is a rear-bottom perspective view of the example air circulation system of FIG. 9 coupled to a surface of a cargo container;

FIG. 12 is a cross sectional view along the line 12-12 of FIG. 10.

FIG. 13 is a rear-bottom perspective view of an example air circulation system mounted on a bracket in a stowed position; and

FIG. 14 is a front-top perspective view of the example air circulation system mounted on a bracket in a stowed position of FIG. 13.

### DETAILED DESCRIPTION

The following disclosure describes systems and methods for detecting the presence of smoke and/or fire in cargo containers stored in a passenger cabin of an aircraft. The systems and method described herein may segregate an aircrafts smoke/fire detection from an indication system that detects smoke/fire in each removable cargo container stored in the aircraft. One disclosed system includes one or more conduits, a circulation fan and a smoke detector. The one or more conduits may define a first portion of a closed loop flow path that is used for circulating air through an internal volume defined by a cargo container. The first portion of the closed loop flow path may be external to the internal volume of the cargo container. A second portion of the closed loop flow path may pass through the internal volume defined by the cargo container. The circulation fan may be disposed along the first portion of the closed loop flow path and may be configured to circulate air within the closed loop flow path. The smoke detector may be disposed along the first portion of closed loop flow path and may be configured to detect a presence of smoke in the cargo container. The air circulation system may be exterior to the cargo container.

It may be desirable to have the system exterior to the cargo container since a flight crew may be able to inspect and conduct maintenance of the system without having to monitoring each individual cargo container within a cabin. In addition, inspection and maintenance of the system may some instances occur in the controlled environment of the passenger cabin. Systems described herein may be within the regulated maintenance and inspection program of the aircraft which allows improved control of performance, life and airworthiness of the systems.

It may also be desirable to have the systems described herein quickly connectable to a cargo container or disconnectable from the cargo container to facilitate onboarding and deboarding of the cargo containers from an aircraft.

The term “connected” or “coupled to” may include both direct coupling (in which two elements that are coupled to each other contact each other) and indirect coupling (in which at least one additional element is located between the two elements) unless specified otherwise.

The term “substantially” as used herein may be applied to modify any quantitative representation which could permissibly vary without resulting in a change in the basic function to which it is related.

Terms such as “up to”, “at least”, “greater than”, “less than”, “more than”, “or more”, and the like, include the number recited and such terms refer to ranges that can be subsequently broken down into sub-ranges. In the same manner, all ratios recited herein also include all sub-ratios falling within the broader ratio.

The singular forms “a,” “an,” and “the” include the plural reference unless the context clearly dictates otherwise. The term “and/or” means any one of the items, any combination of the items, or all of the items with which this term is associated.

Aspects of various embodiments are described through reference to the drawings.

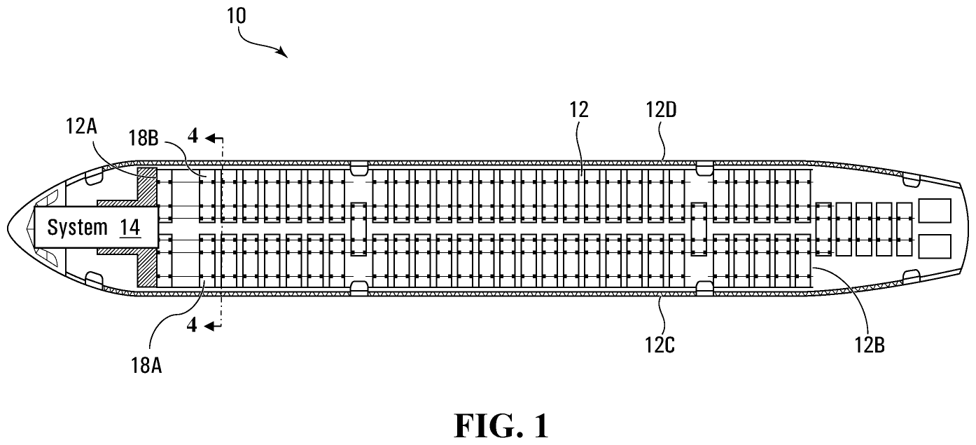

FIG. 1 illustrates a top plan view of an exemplary layout of passenger cabin 12 of aircraft 10 that includes system 14 for detecting a presence of smoke in a plurality of cargo containers 18A, 18B (referred herein after in the singular) transported in passenger cabin 12 of aircraft 10. Cabin 12 may have front and back ends 12A, 12B (also referred to as fore and aft ends) and left and right ends 12C, 12D (also referred to as port and starboard sides). Cabin 12 may be designed to accommodate a plurality of seating modules that are coupled to seating tracks arranged in rows. As depicted, rows may extend along each window side of cabin 12. As depicted, the seating tracks may also be arranged in one or more columns. It should be understood that the seating tracks installed in cabin 12 may be arranged differently having a different number of rows and/or a different number of columns.

To allow cargo container 18 to be accommodated and restrained within cabin 12, one or more guide rails may be installed in cabin 12 (not shown). The guide rails may engage one or more rails attached to a bottom surface of cargo container 18 (not shown). In another embodiment, the cargo container 18 may be coupled to one or more slots in the floor of cabin 12 to restrain cargo container 18. In some embodiments, cabin 12 may be modified to remove some or all of the seating modules from their corresponding seat tracks. At least some of the guide rails may be installed on the seating tracks, and cargo container 18 may be selectively positioned along one of these guide rails and locked in position before flight. In some embodiments, the guide rails and rails may be similar to the type of guide rails and rails disclosed in U.S. patent application Ser. No. 17/366,957 (titled: STORAGE SYSTEM FOR AN AIRPLANE), which is incorporated herein by reference. In some embodiments, the cargo container 18 may be coupled to existing hard points in cabin 12 such that the cargo container 18 is fixed on the hard point and loaded while on-aircraft.

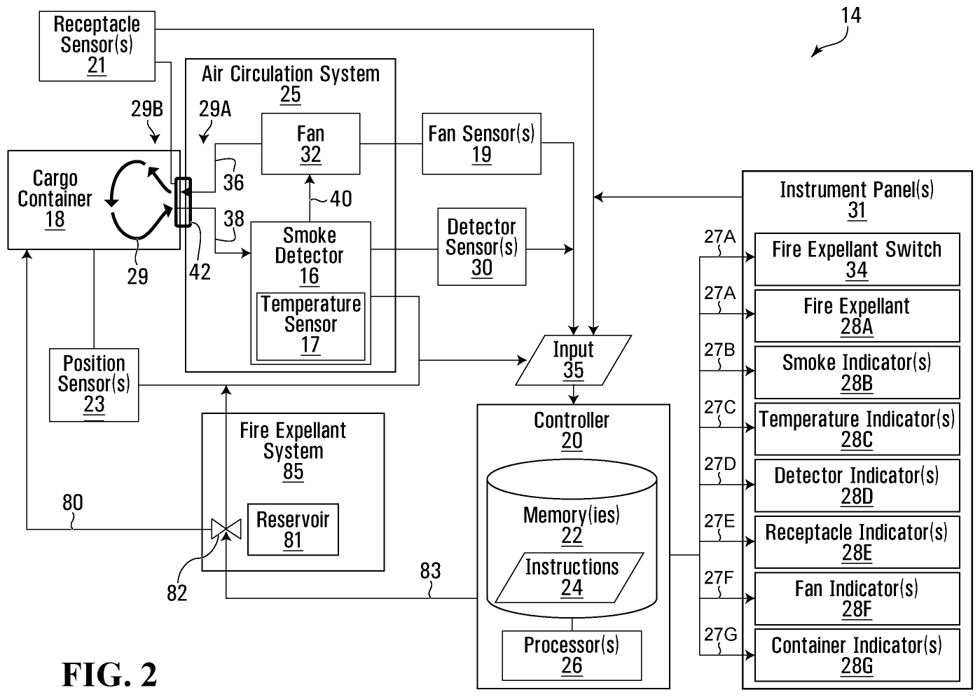

FIG. 2 is a schematic diagram of an exemplary system 14 that may be used for detecting the presence of smoke, heat, and/or fire in cargo container 18 when cargo container 18 is being stored in cabin 12 of aircraft 10. Cargo container 18 may be locked in position on one of the guide rails installed on a seating track in cabin 12 (not shown).

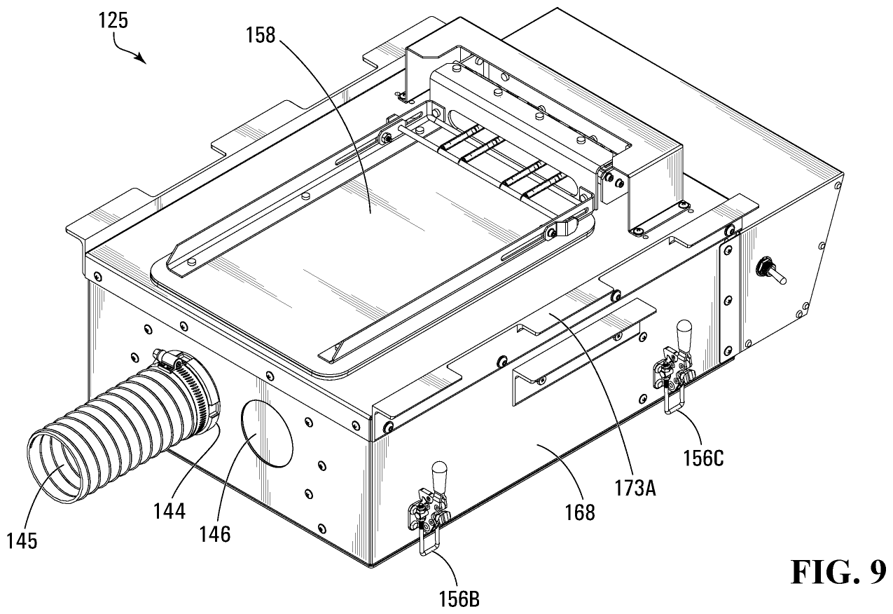

System 14 may include air circulation system 25 that is configured to circulate and monitor air in an internal volume defined by cargo container 18. Air circulation system 25 may include first conduit 36, second conduit 38, third conduit 40, circulation fan 32, smoke detector 16, temperature sensor 17, and receptacle 42 for interfacing with a cargo container. Receptacle 42, 142 may also be referred to herein as an “interface”. As depicted, conduits 36, 38, 40 may be configured to define first portion 29A of closed loop flow path 29. In some embodiment, conduits 36, 38, 40 may be absent as fan 32, smoke detector 16, temperature sensor 17, receptacle 42, 142 are integrated within the same housing as shown in FIG. 9. Closed loop flow path 29 may define a path for circulating air through an internal volume defined by cargo container 18. As depicted, second portion 29B of closed loop flow path 29 may pass through an internal volume defined by cargo container 18. In some embodiments, air circulation system 25 may be one of a plurality of air circulation systems 25 in cabin 12. In these embodiments, each one of air circulation systems 25 may be positioned adjacent to a different location in cabin 12 where cargo container 18 may be restrained during flight.

System 14 may include one or more position sensors 23, one or more fan sensors 19, one or more detector sensors 30, one or more receptacle sensors 21, controller 20 and instrument panel 31. Instrument panel 31 may be located within the cockpit of aircraft 10 or nearby a flight attendant station or both, and may include fire expellant indicators 28A, smoke indicators 28B, temperature indicators 28C, detector indicators 28D, receptacle indicators 28E, fan indicators 28F, and container indicators 28G (collectively referred to hereinafter as “indicators 28”). In some embodiments, each one of indicators 28 may be included on a different instrument panel. In some embodiments, each sensor, and/or detector described herein may communicate with controller 20 and/or indicator panel 31 with electromechanical relays. In other embodiments, one or more sensor(s), and/or detector(s) described herein digital or analogue sensors.

Controller 20 may be configured to receive input 35 from smoke detector 16, temperature sensor 17, position sensors 23, fan sensors 19 and receptacle sensors 21 via one or more communication terminals/ports. Controller 20 may be an analogue controller. Controller 20 may include one or more data processors 26 (referred hereinafter in the singular) and one or more computer-readable memories 22 (referred hereinafter in the singular) storing machine-readable instructions 24 executable by data processor 26 and configured to cause data processor 26 to generate one or more outputs (e.g., signals) for causing the execution of one or more steps of the methods described herein. Controller 20 may be installed in a cockpit of aircraft 10. Controller 20 may be an electromechanical relay communicating electrical signals as data to instrument panel 31. In an embodiment, controller 20 and/or instrument panel 31 may be adjacent to an existing cabin crew seat (e.g. flight attendant station) or in a desired position accessible to crew and reachable from a seated position.

Data processor 26 may include any suitable device(s) configured to cause a series of steps to be performed by controller 20 so as to implement a computer-implemented process such that instructions 24, when executed by controller 20 or other programmable apparatus, may cause the functions/acts specified in the methods described herein to be executed. Data processor 26 may include, for example, any type of general-purpose microprocessor or microcontroller, a digital signal processing (DSP) processor, an integrated circuit, a field programmable gate array (FPGA), a reconfigurable processor, other suitably programmed or programmable logic circuits, or any combination thereof.

Memory 22 may include any suitable machine-readable storage medium. Memory 22 may include non-transitory computer readable storage medium such as, for example, but not limited to, an electronic, magnetic, optical, electromagnetic, infrared, or semiconductor system, apparatus, or device, or any suitable combination of the foregoing. Memory 22 may include a suitable combination of any type of computer memory that is located either internally or externally to controller 20. Memory 22 may include any storage means (e.g. devices) suitable for retrievably storing machine-readable instructions 24 executable by data processor 26.

Various aspects of the present disclosure may be embodied as systems, devices, methods and/or computer program products. Accordingly, aspects of the present disclosure may take the form of an entirely hardware embodiment, an entirely software embodiment or an embodiment combining software and hardware aspects. Furthermore, aspects of the present disclosure may take the form of a computer program product embodied in one or more non-transitory computer readable medium(ia) (e.g., memory 22) having computer readable program code (e.g., instructions 24) embodied thereon. Computer program code for carrying out operations for aspects of the present disclosure in accordance with instructions 24 may be written in any combination of one or more programming languages. Such program code may be executed entirely or in part by controller 20 or other data processing device(s). Based on the present disclosure, one skilled in the relevant arts could readily write computer program code for implementing the methods described herein.

Smoke detector 16 may be configured to detect a presence of smoke within cargo container 18 and may be disposed along first portion 29A of closed loop flow path 29. Similarly, temperature sensor 17 may be configured to sense the temperature of air circulating through cargo container 18 and may be disposed along first portion 29A Data from smoke detector 16, and/or temperature sensor 17, may be communicated to controller 20. The transmission of data from smoke detector 16, and/or temperature sensor 17, may be commanded by data processor 26 based on machine-readable instructions 24. Controller 20 may receive such data on a substantially continuous basis or intermittently so that the data may be available to controller 20 substantially in real-time. In some embodiments, controller 20 may receive data indicative of a concentration of smoke in the air, and/or temperature of the air, circulated through the internal volume defined by cargo container 18. In some embodiments, smoke detector 16 may be a smoke detector that is configured to measure a concentration of smoke in an air stream such as the smoke detector manufactured by Siemens that has a model no. GMC1103-02 or Siemens model no. PPC-1200. It should be understood that smoke detector 16 may be a detector of a different type. For example, smoke detector 16 may be configured to measure a temperature of air circulated through cargo container 18 and controller 20 may be configured to infer a concentration of smoke within the air using the measured temperature.

Based on input 35 from smoke detector 16, controller 20 may be configured to determine if the concentration of smoke and/or temperature within the air circulated in the internal volume of cargo container 18 exceeds a prescribed value. In some embodiments, the prescribed value may be a smoke concentration of about zero or a temperature set point, e.g. above about 57° C. If the concentration of smoke within the air exceeds the prescribed value, controller 20 may be configured to generate output signal 27B causing one of smoke indicators 28B to be turned on, e.g. a light indicator 33B. Light indicators 33A-33F may also be referred to herein as light-emitting diodes (LED) 33A-33F Output signal 27B may be transmitted from controller 20 directly to instrument panel 31. In some embodiments, controller 20 may be hardwired to instrument panel 31. Controller 20 may be configured to transmit output signal 27B to a container panel 131 located on air circulation system 125 which may be positioned on a cargo container. Upon receiving signal 27B, LED 133B may be activated to alert flight crew that the container has triggered an alarm indicating that smoke has been detected.

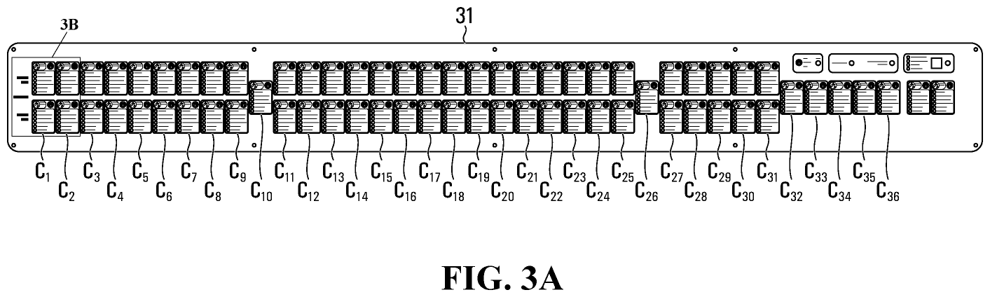

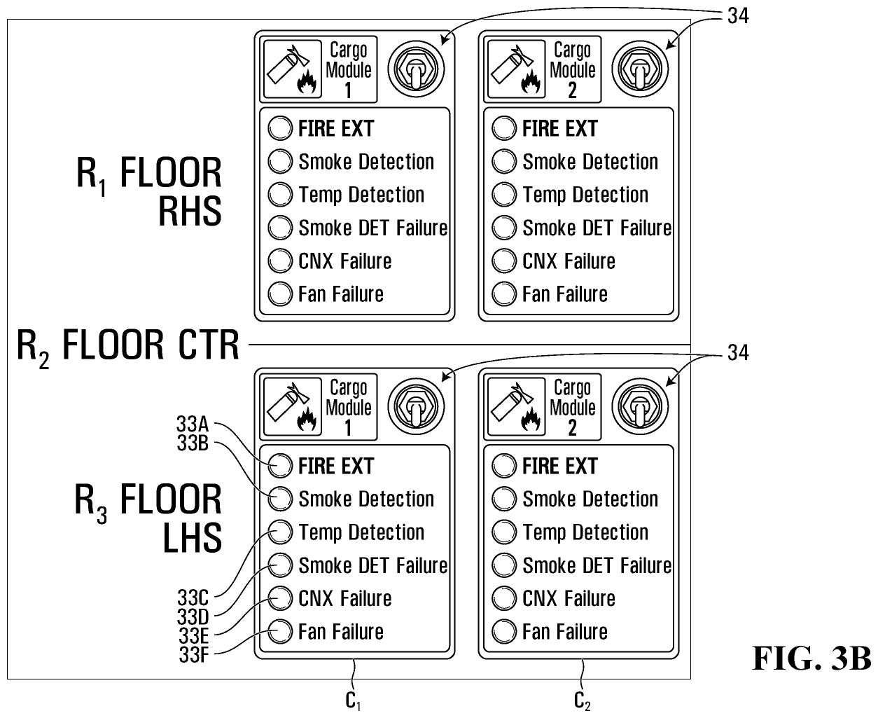

Position sensors 23 may be one or more proximity sensors and/or one or more push-button sensors located within cabin 12 that are configured to determine a location of cargo container 18 within cabin 12. Position sensors 23 may be installed at various locations within cabin 12 and may be positioned proximate to an expected location where cargo container 18 may be locked in place during flight. In some embodiments, each position sensor 23 may be positioned adjacent to or may be incorporated in a respective one of the guide rails installed in cabin 12 that are used to restrain cargo container 18 during flight. In an example, position sensor 23 may be part of a closed loop circuit that is completed when a lock couples a cargo container to one of the guide rails described in U.S. patent application Ser. No. 17/366,957 (titled: STORAGE SYSTEM FOR AN AIRPLANE, the position sensor 23 configured to relay the cargo container is in a desired position within the aircraft. Data (including signal(s)) from position sensors 23 may be communicated to controller 20. The transmission of data from position sensors 23 may be commanded by data processor 26 based on machine-readable instructions 24. Controller 20 may receive such data on a substantially continuous basis or intermittently so that the data may be available to controller 20 substantially in real-time. In some embodiments, controller 20 may receive data indicative of a row and a column of a seat track where cargo container 18 is locked on. In some embodiments, controller 20 may receive an electric signal associated a position sensor 23 for communicating an alert to activate a counterpart indicator on instrument panel 31. In an example, position sensor 23 may cause output signal 27G for communicating an alert and to activate container indicator 28G, e.g. causing all indicators on panel 31 at a row/column to have background illumination. Continuing the example, when a position sensor 23 at a position corresponding to R₃, C₁ in aircraft 10 is activated by a container locked at the position, controller 20 may cause signal 27G to be generated for communicating an alert and activate container indicator 28G which may illuminate the lights on panel 31 at R₃, C₁ shown in FIG. 3B.

Based on input 35 from position sensors 23, controller 20 may be configured to determine the location of cargo container 18 within cabin 12. In some embodiments, the location of cargo container 18 within cabin 12 of aircraft 10 may be determined before output signal 27G is generated. In these embodiments, controller 20 may be configured to use the location of cargo container 18 to generate output signal 27G. In these embodiments, output signal 27G may cause a specific one of indicators 28G that is associated with the location of cargo container 18 to be turned on. In an example, indicator 28G may cause each led 33A-33F corresponding to the position of the cargo container on instrument panel 31 to be back-lit indicating that a cargo container has been positioned at the location, e.g. LED 33A-33F at R₃, C₁ would be back-lit if a cargo container is positioned at the location associated with R₃, C₁ in the cabin. Position sensors 23 which do not sense a cargo container at its position may cause indicator 28G to turn off each LED 33A-33F 33F corresponding to the position of the position sensor 23 on instrument panel 31.

Detector sensor(s) 30 may be one or more detector sensor(s) 30 coupled to smoke detector 16 and/or temperature sensor 17 to sense of smoke detector 16 and/or temperature sensor 17 are operational or require maintenance. Detector sensors 30 may be installed with each smoke detector 16 and/or temperature sensor 17. In some embodiments, each detector sensors 30 may be positioned in each air circulation system 25. Data (including signal(s)) detector sensors 30 may be communicated to controller 20. The transmission of data from detector sensors 30 may be commanded by data processor 26 based on machine-readable instructions 24. Controller 20 may receive such data on a substantially continuous basis or intermittently so that the data may be available to controller 20 substantially in real-time. In some embodiments, controller 20 may receive data indicative of a row and a column of a seat track where cargo container 18 is locked on.

FIG. 3A illustrates a front view of a portion of instrument panel 31 that includes a plurality of indicator modules 28. Each indicator module 28 may be associated with a specific location in cabin 12 where cargo container 18 may be locked in place. Each indicator module 28 may comprise a plurality of indicators, e.g. LED 33A-33F. As depicted, indicator module 28 may be organized on instrument panel 31 in rows R1-R3 and columns C1-C36 that correspond to rows and columns of seat tracks within cabin 12 where cargo container 18 may be locked in place. Organizing indicator modules 28 on instrumental panel 31 in this manner may enable a flight crew to easily identify the location of cargo container 18 where smoke/fire has been detected. When cargo container 18 is locked in place along one of the seat tracks within cabin 12 and an input if received from one of sensor(s) 16, 17 19, 21, 23, 30, controller 20 may generate output signal 27A-27G configured to cause a counterpart one of indicators 28A-28G associated with the location and sensor where cargo container 18 is locked in place to be turned on. For example, when cargo container 18 is locked in place along one of the seat tracks within cabin 12 and the concentration of smoke within the air exceeds a prescribed concentration, controller 20 may generate output signal 27B to cause a counterpart indicators 28B associated with the location where cargo container 18 is locked in place to be turned on.

In some embodiments, controller 20 may be configured to determine an amount of deviation between a measured value and a threshold value (i.e. alarm condition), e.g. when the concentration of smoke within the air circulated in the internal volume defined by cargo container 18 and a prescribed smoke concentration. As depicted in FIG. 3A and FIG. 3B, each indicator module 28 may include multiple LEDs 33A-33F that are each associated with a counterpart indicator 27A-27G. Initially, as described above, when a cargo container is locked into position, controller 20 may signal 27G container indicator 28G to provide background lighting to LEDs 33A-33F corresponding to the position of the cargo container 18 in aircraft 10. In an example, controller 20 may measure an amount of deviation between the concentration of smoke within the air and the prescribed concentration sensed by smoke sensor 16. Continuing the example, if the deviation is greater than a first threshold, controller 20 may signal 27B to a smoke indicator 28B corresponding to the smoke sensor location to turn LED 33B on. If the deviation is lower than the first threshold, LED 33B may be turned off. Temperature LED 33C may be activated and/or deactivated in the same manner as LED 33B by measuring if the temperature measured by a temperature sensor 17 is above or below a threshold value respectively. Controller 20 may be configured to transmit output signal 27B to a container panel 131 located on air circulation system 125 which may be positioned on a cargo container when in use. Upon receiving signal 27B, LED 133B may be activated to alert flight crew which container has triggered an alarm.

Detector sensor(s) 30 may sense an operational status of counterpart smoke detector 16 and/or temperature sensor 17. In an example, when a fault is detected at smoke detector 16 and/or temperature sensor 17, detector sensor 30 may signal controller 20 which generates signal 27D for communicating an alert and activate LED light 27D notifying an operator that smoke detector 16 and/or temperature sensor 17 are no longer providing a reliable signal and/or require maintenance. Controller 20 may be configured to transmit output signal 27D to a container panel 131 located on air circulation system 125 which may be positioned on a cargo container when in use. Upon receiving signal 27D, LED 133D may be activated to alert flight crew which container has triggered an alarm.

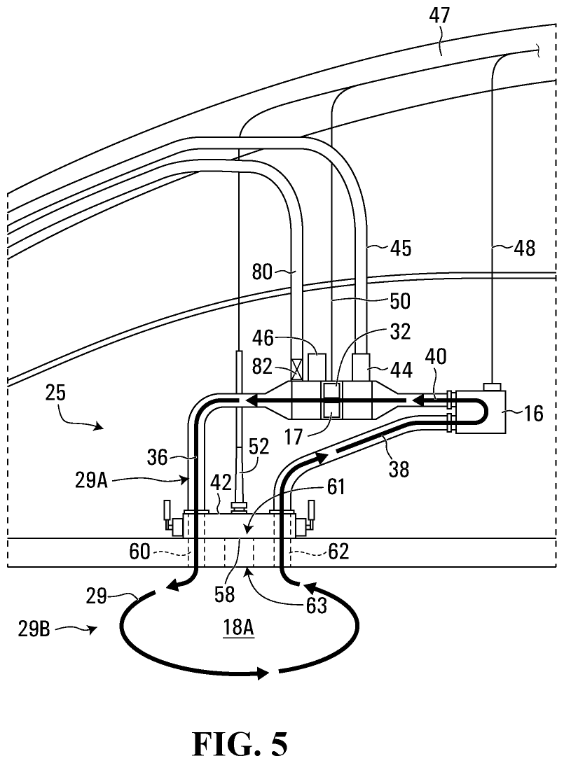

Receptacle sensor(s) 21 may detect if a receptacle 42 is coupled to a cargo container 18. In an embodiment, receptacle sensor 21 may be one or more proximity sensors and/or one or more push-button sensors and/or any analogue/digital sensor for detecting if the internal volume defined by cargo container 18 is in fluid communication with first portion 29A of closed loop path 29. As depicted in FIG. 5, system 14 may include receptacle 42 that is configured to be coupled to a surface of cargo container 18A. Receptacle 42 may be used for establishing fluid communication between first portion 29A of closed loop path 29 and the internal volume defined by cargo container 18A. In some embodiments, detecting if first portion 29A of closed loop path 29 is fluidly connected to an internal volume defined by cargo container 18 may involve detecting if receptacle 42 is coupled to the surface of cargo container 18A. Data from receptacle sensors 21 may be communicated to controller 20. The transmission of data from receptacle sensors 21 may be commanded by data processor 26 based on machine-readable instructions 24. Controller 20 may receive such data on a substantially continuous basis or intermittently so that the data may be available to controller 20 substantially in real-time. In some embodiments, controller 20 may receive data that indicates if receptacle 42 is coupled to the surface of cargo container 18. In an embodiment, when receptacle 42 is coupled to mounting plate 54 an circuit of receptacle sensor 21 will close to signal controller 20 to generate signal 28G to container indicator 28G.

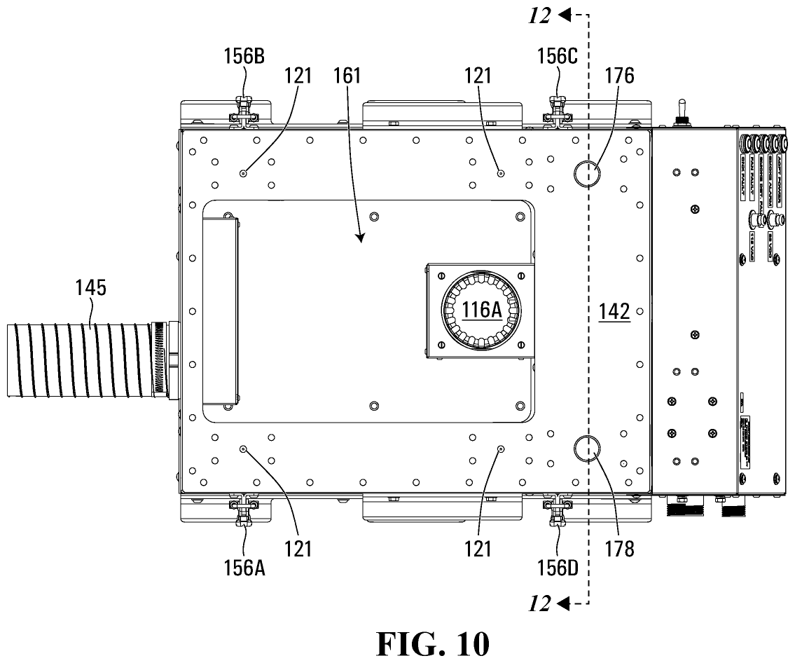

Based on input 35 from receptacle sensors 21, controller 20 may be configured to determine if receptacle 42 is coupled to the cargo container such that first portion 29A of closed loop path 29 is fluidly connected to an internal volume defined by cargo container 18A. If first portion 29A of closed loop path 29 is fluidly connected to the internal volume defined by cargo container 18A, controller 20 may be configured to generate output signal 27E causing one of receptacle indicators 28E to be turned off to indicate that the receptacle at a corresponding row and column is connected to a cargo container. Output signal 27E may be transmitted from controller 20 directly to instrument panel 31. In some embodiments, controller 20 may be configured to use the location of cargo container 18 to generate output signal 27E. Receptacle indicators 28E may be organized on instrument panel 31 in rows and columns that correspond to rows and columns of seat tracks within cabin 12 where cargo container 18 may be locked in place, e.g. see cargo container 18A and 18B shown in FIG. 1. When cargo container 18 is locked in place along one of the seat tracks within cabin 12 and first portion 29A of closed loop path 29 is fluidly connected to the internal volume defined by cargo container 18, controller 20 may be configured to generate output signal 27E that causes the specific one of receptacle indicators 28E, e.g. LED light 33E, associated with the location where cargo container 18 is locked in place to be turned off. Controller 20 may be configured to transmit output signal 27E to a container panel 131 located on air circulation system 125 which may be positioned on a cargo container 18 when in use. Upon receiving signal 27E, LED 133E may be turned to alert flight crew that the cargo container 18 has been successfully coupled to receptacle 42, 142. As shown in FIG. 10, receptacle 142 may comprise a plurality of receptacle sensors 121, each of which may be activated to indicate successful coupling to a cargo container before output signal 27E is generated.

One or more fan sensors 19 may be incorporated in circulation fan 32 or may be positioned adjacent to circulation fan 32. One or more fan sensors 19 may be hall sensors or other types of sensor that are configured to measure a rotational speed of a rotor of circulation fan 32. Data from one or more fan sensors 19 may be communicated to controller 20. The transmission of data from fan sensors 19 may be commanded by data processor 26 based on machine-readable instructions 24. Controller 20 may receive such data on a substantially continuous basis or intermittently so that the data may be available to controller 20 substantially in real-time. In some embodiments, controller 20 may receive data indicative of a rotational speed of the rotor of circulation fan 32 and if the rotational speed of the rotor drops below a threshold value then controller will generate signal 27F to fan indicator 28F which may light LED 33F.

Based on input 35 from fan sensors 19, controller 20 may be configured to determine if the rotational speed of the rotor of circulation fan 32 is equal to the expected rotational speed of circulation fan 32. The expected rotational speed of circulation fan 32 may be equal to a rotational speed of circulation fan 32 set by flight crew. If the rotational speed of the rotor of circulation fan 32 is different than the expected rotational speed of circulation fan 32, controller 20 may be configured to generate output signal 27F causing one of fan indicators 28C to be turned on. Output signal 27F may be transmitted from controller 20 directly to instrument panel 31. In some embodiments, controller 20 may be configured to use the location of cargo container 18 to generate output signal 27F. Fan indicators 28F may be organized on instrument panel 31 in rows and columns that correspond to rows and columns of seat tracks within cabin 12 where cargo container 18 may be locked in place (not shown). When cargo container 18 is locked in place along one of the seat tracks within cabin 12 and the rotational speed of the rotor of circulation fan 32 is different than the expected rotational speed of circulation fan 32, controller 20 may be configured to generate output signal 27F that causes the specific one of fan indicators 28F, e.g. LED 38F, associated with the location where cargo container 18 is locked in place to be turned on. Controller 20 may be configured to transmit output signal 27F to a container panel 131 located on air circulation system 125 which may be positioned on a cargo container 18 when in use. Upon receiving signal 27F, LED 133F may be activated to alert flight crew which container has triggered an alarm.

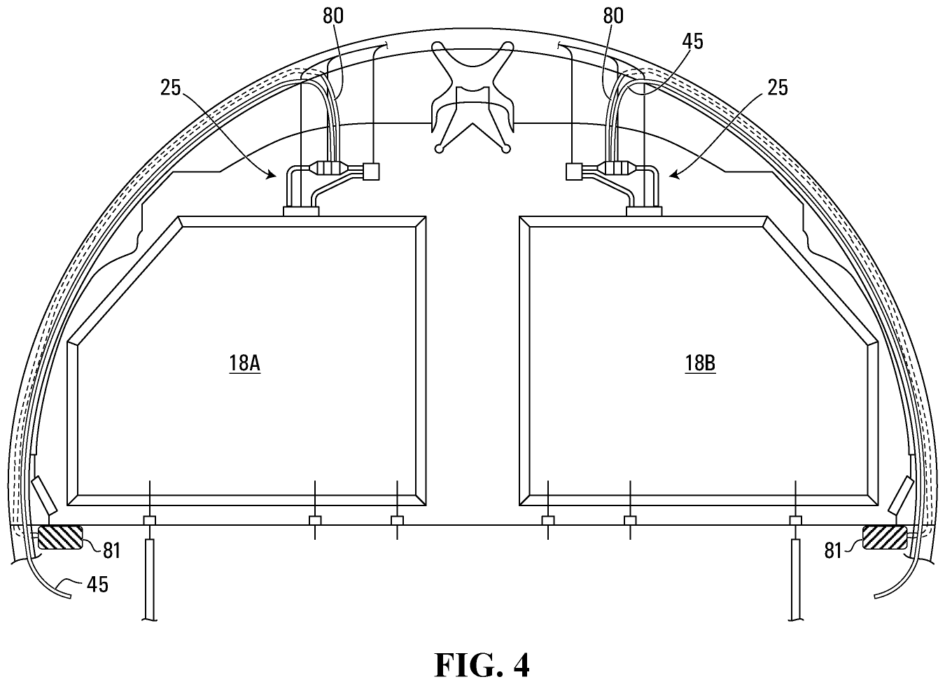

System 14 may also comprise a fire expellant system 85. Fire expellant system 85 may comprise a reservoir 81 for fire expellant such as Halon or any fire suppressant approved for use in aircraft. Reservoir 81 may be coupled each cargo container 18 via expellant conduit 80 and a plurality of valve(s) 82. Valve 82 may be any valve (e.g. ball valve, gate valve, etc.) configured to open and/or close when signaled or at a physical condition within a cargo container (e.g. at a specified pressure). A distinct valve 82 may be positioned between reservoir 81 and each cargo container 18. In an example valve 82 is a control valve. Controller 20 may communicate with valve 82 by sending signal 83 to open and/or close. Each valve 82 may be opened by a counterpart fire expellant switch 34 on instrument panel 31. As shown in FIGS. 3A and 3B, a fire expellant switch 34 may be associated with each cargo container position. When opened, valve 82 may supply pressurized fire expellant to a desired cargo container 18 and communicate with controller 20 to indicate that fire expellant has been deployed. When a valve 82 is opened and has signaled controller 20 that the valve 82 has opened, controller 20 may be configured to generate output signal 27A that causes the specific one of fire expellant indicators 28A, e.g. LED 38A, associated with the location where cargo container 18 is locked in place to be turned on. Data (including signal(s)) may be communicated to controller 20. The transmission of data from valve 82 may be commanded by data processor 26 based on machine-readable instructions 24. Controller 20 may receive such data on a substantially continuous basis or intermittently so that the data may be available to controller 20 substantially in real-time. In some embodiments, controller 20 may receive data indicative of a row and a column of a seat track where cargo container 18 is locked on. In some embodiments, controller 20 may comprise instructions 24 to not open valve 82 (despite fire expellant switch 34 being activated) unless receptacle sensor 21 and position sensor 23 associated with a cargo container coupled to valve 82 indicate receptacle 42 is coupled to a cargo container in its locked position. FIG. 4 illustrates a cross-sectional view of cabin 12 taken along line 4-4 in FIG. 1 showing cargo containers 18A, 18B. Cargo container 18A may be spaced apart from cargo container 18B. As depicted, the air that passes through each of cargo containers 18A, 18B may be circulated and monitored using a respective air circulation system 25. Each cargo container 18A, 18B may comprise a port for coupling to a fire extinguisher to receive expellant from the fire extinguisher to supress a fire. Example expellant(s) may include halon, chemical foam, dry powder, carbon dioxide fire extinguisher expellant, or any fire suppressant approved for use in an aircraft. A reservoir 81 for fire expellant may be coupled to each of cargo containers 18A, 18B via an expellant conduit 80 and valve 82. As shown in FIG. 4, reservoir 81 is positioned below the floor of the aircraft; however, the reservoir may be position anywhere on airframe of aircraft 10, e.g. sidewall, overhead, etc.

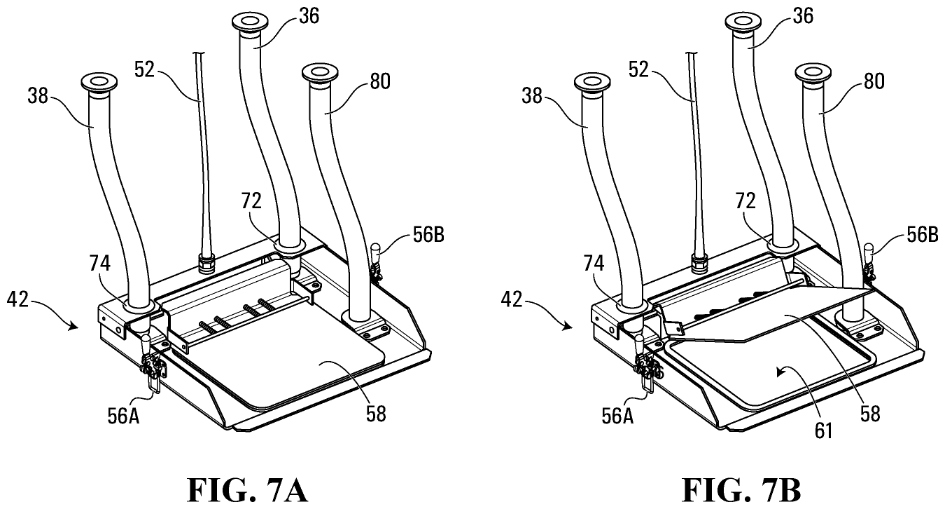

FIG. 5 illustrates a front view of air circulation system 25 used for circulating and monitoring air that passes through an internal volume defined by cargo container 18A. As depicted, air circulation system 25 may include first conduit 36, second conduit 38, third conduit 40, circulation fan 32, smoke detector 16, receptacle 42, overpressure valve 44 and equalization valve 46. Conduits 36, 38, 40 may define first portion 29A of closed loop flow path 29 that is used for circulating air through cargo container 18A. As depicted, second portion 29B of closed loop flow path 29 may pass through the internal volume defined by cargo container 18A. Air circulation system 25 may be exterior to cargo container 18A and may be secured to a structure in cabin 12 that is configured to support one or more overhead bins (shown in FIG. 7). It may be advantageous to have air circulation system 25 exterior to cargo container 18A since a flight crew and/or ground crew may be able to inspect and conduct maintenance of air circulation system 25 in the controlled environment of cabin 12. If an air circulation system similar to air circulation system 25 was incorporated within cargo container 18A, inspection and maintenance of the air circulation system would have to be completed for each cargo container 18A outside of aircraft 10 and before cargo container 18A is loaded into aircraft 10. This may be time-consuming and inconvenient.

First conduit 36 may be configured to supply air to the internal volume defined by cargo container 18A through first opening 60 defined on a surface of cargo container 18A. In some embodiments, first conduit 36 may extend between circulation fan 32 and receptacle 42. Second conduit 38 may be configured to receive air from the internal volume defined by cargo container 18A through second opening 62 defined on a surface of cargo container 18A. In some embodiments, second conduit 38 may extend between receptacle 42 and smoke detector 16.

Circulation fan 32 may be configured to circulate air within closed loop flow path 29. In some embodiments, circulation fan 32 may be a centrifugal fan assembly having a built-in performance fan sensor such as the centrifugal fan assembly manufactured by Emteq that has a model no. MT3-0368-2-08. Circulation fan 32 may be disposed along first portion 29A of closed loop flow path 29. Circulation fan 32 may be configured to receive power/data signals via one or more electrical lines 50. One or more fan sensors 19, which may be incorporated in circulation fan 32, may be configured to transmit data indicative of a rotational speed of a rotor of circulation fan 32 to controller 20 using one or more electrical lines 50. In some embodiments, one or more electric lines 50 may be fed through fuselage frame 47 and housing 68 to provide power and data signals to fan sensor 19, circulation fan 32, smoke detector 16, temperature sensor 17, detector sensor 30, and controller 20.

Smoke detector 16 may be configured to detect a presence of smoke within the air circulated through the internal volume defined by cargo container 18A. Smoke detector 16 may be configured to receive air from cargo container 18A via second conduit 38 and may measure the concentration of smoke within the air. Third conduit 40 may be disposed between smoke detector 16 and circulation fan 32. Third conduit 40 may be configured to direct air from smoke detector 16 towards circulation fan 32. Smoke detector 16 may be configured to receive power via one or more electrical lines 48. Smoke detector 16 may be configured to transmit data indicative of a concentration of smoke within the air circulated through the internal volume defined by cargo container 18A to controller 20 using one or more electrical lines 48.

Overpressure valve 44 may be disposed between smoke detector 16 and circulation fan 32 along first portion 29A of closed loop flow path 29. Overpressure valve 44 may be a pressure-control valve that is configurable between an opened and closed position. Overpressure valve 44 may be opened to vent some air in closed loop flow path 29 to a location exterior to cabin 12 when the air pressure within closed loop flow path 29 exceeds a prescribed pressure. When overpressure valve 44 is opened, some air in closed loop flow path 29 may be received in bypass duct 45 that directs air to a location underneath cabin 12. In some embodiments, the air may be directed to an ambient environment via an exhaust system of aircraft 10 such as an aircraft outflow valve.

Equalization valve 46 may be a pressure-control valve that is configurable between an opened and closed position. As aircraft 10 ascends or descents, pressure inside cabin 12 will decrease or increase respectively. Avoid material fatigue and/or rupture of cargo containers, equalization valve 46 may open to equalize the pressure between the closed loop flow path 29 (and the interior of cargo container 18A) and the exterior of cargo container 18A. Equalization valve 46 may be opened to allow air to be received in closed loop flow path 29 from cabin 12 when the air pressure within closed loop flow path 29 is less than the prescribed pressure to open overpressure valve 44.

Receptacle 42 may be coupled to a surface of cargo container 18A and may be configured to secure port 72 of first conduit 36 and port 74 of second conduit 38 to the surface of cargo container 18A such that port 72 of first conduit 36 is in fluid communication with first opening 60 and port 74 of second conduit 38 is in fluid communication with second opening 62. In some embodiments, receptacle 42 may have receptacle sensors 21 incorporated in receptacle 42. Receptacle sensors 21 may be configured to receive power via one or more electrical lines 52. Receptacle sensors 21 may be configured to transmit data indicating if the internal volume defined by cargo container 18A is fluidly connected to first portion 29A of closed loop flow path 29 to controller 20 using one or more electrical lines 52.

As shown in FIG. 5, a reservoir 81 for fire expellant may be coupled to cargo container 18A via expellant conduit 80 and valve 82. Valve 82 may be a control valve controlled to supply fire expellant from reservoir 81 to cargo container 18A. As described above, in an example, valve 82 may be signalled to open by a switch 34 in communication with valve 82. In other example, valve 82 may be a pressure safety valve configured to open when the pressure inside cargo container 18A exceeds a prescribed pressure (e.g. a pressure indicative of a fire).

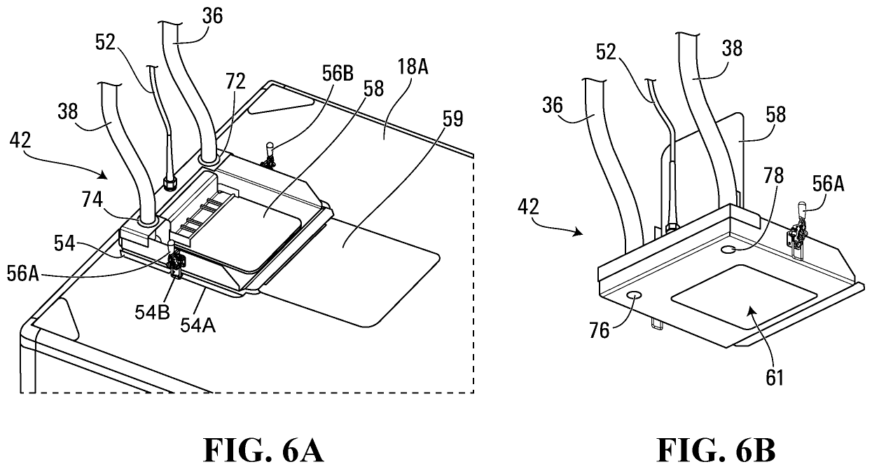

FIGS. 6A and 6B illustrate two perspective views showing an example receptacle 42 that may be releasably coupled to a surface of cargo container 18A. In some embodiments, cargo container 18A may have a housing and mounting surface 54 on the surface of housing, e.g. a mounting plate. As shown, mounting surface 54 may comprise alignment members 54A such as rails and/or grooves to align receptacle 42 on the mounting surface such that opening 63 of cargo container is sealably covered by receptacle 42. Receptacle 42 may be coupled to mounting surface 54 with a releasable coupling mechanism. As shown in FIGS. 6A, 6B, 7A, and 7B, the releasable coupling mechanism may be hook and clips (“clips”) 56A and 56B of receptacle 42 used to clip receptacle 42 onto members 54B of mounting surface 54. As depicted, clips 56A and 56B may clip onto opposite ends of mounting plate 54. It should be understood that other releasable coupling mechanisms may be used to secure receptacle 42 to the surface of cargo container 18A. In another embodiment, releasable coupling mechanism may be a magnet, e.g. a magnet on any one of the receptacles 42 and/or mounting surface 54 positioned to couple to each other or ferrous metal. In another embodiment, releasable coupling mechanism may be a quick connect fitting or any connector configured to couple objects together. In another embodiment, releasable coupling mechanism may comprise a fastener, such as a screw fastener for releasably coupling the receptacle to the mounting plate.

Openings 76 and 78 may be defined in receptacle 42 for receiving posts (not shown) on container 18A which aid in alignment of receptacle 42 on container 18A. First conduit 36 may be coupled to receptacle 42 such that port 72 of first conduit 36 is in fluid communication with opening 76 defined in receptacle 42 and first opening 60 defined in cargo container 18A. Second conduit 38 may be coupled to receptacle 42 such that port 74 of second conduit 38 is in fluid communication with opening 78 defined in receptacle 42 and second opening 62 defined in cargo container 18A. In some embodiments, first conduit 36, second conduit 38 and receptacle 42 may be integrally formed.

Receptacle 42 may include pressure valve comprising a decompression panel 58 that is movable between a closed position and an opened position. As depicted in FIG. 6A, decompression panel 58 is biased to a closed position. Receptacle 42 defines opening 61 which may be configured to overlap with third opening 63 defined in cargo container. When decompression panel 58 is in a closed position, decompression panel 58 may be positioned to cover third opening 63 defined in cargo container 18A to prevent air from being vented from the internal volume defined by cargo container 18A to cabin 12. As depicted in FIG. 6B, decompression panel 58 is in an open position. When decompression panel 58 is in an opened position, decompression panel 58 may expose third opening 63 to permit air to be vented from the internal volume defined by cargo container 18A to cabin 12 thereby decreasing pressure in cargo container 18A. Decompression panel 58 may operate as a pressure safety valve to prevent rupture of cargo container 18A.

Decompression panel 58 may be configured to transition from the closed position to the opened position when a pressure within cargo container 18 is greater than specified pressure above a pressure within cabin 12. In some embodiments, decompression panel 58 may be a spring-loaded flap that is configured to open when a pressure within cargo container 18 is greater than a pressure within cabin 12 by 14 kPa. For example, decompression panel 58 may transition from a closed position to an opened position in an emergency situation such as a situation when a window in cabin 12 is blown out and a pressure in cabin 12 significantly drops. In some embodiments, the pressure differential required to cause decompression panel 58 to transition from a closed configuration to an opened configuration may be significantly greater than the pressure differential required to cause the overpressure/equalization valves 44, 46 to be opened. In an embodiment, decompression panel 58 opens in less than 0.2 seconds.

Mounting plate 54 may include environmental flap 59, which may be a spring-loaded flap, that is configurable between an opened and closed position. As depicted in FIG. 6A, environmental flap 59 may be in an opened position when receptacle 42 is releasably coupled to a mounting plate 54 and/or a surface of cargo container 18A. In the opened position, environmental flap 59 may be configured to expose decompression panel 58 to cabin 12. When receptacle 42 is not coupled to a surface of cargo container 18A, environmental flap 59 may be biased to be in a closed position. In the closed position, environmental flap 59 may cover first opening 60, second opening 62 and third opening 63 thereby protecting cargo container 18A or 18B from being exposed to environmental or handling damages.

FIGS. 7A and 7B illustrate another embodiment of receptacle 42 having the same elements as the receptacle illustrated in FIGS. 6A and 6B with an expellant conduit 80. As described above, expellant conduit 80 may be coupled to valve 82 and reservoir 81 to receive fire expellant for extinguishing a fire in a cargo container to which receptacle 42 is coupled.

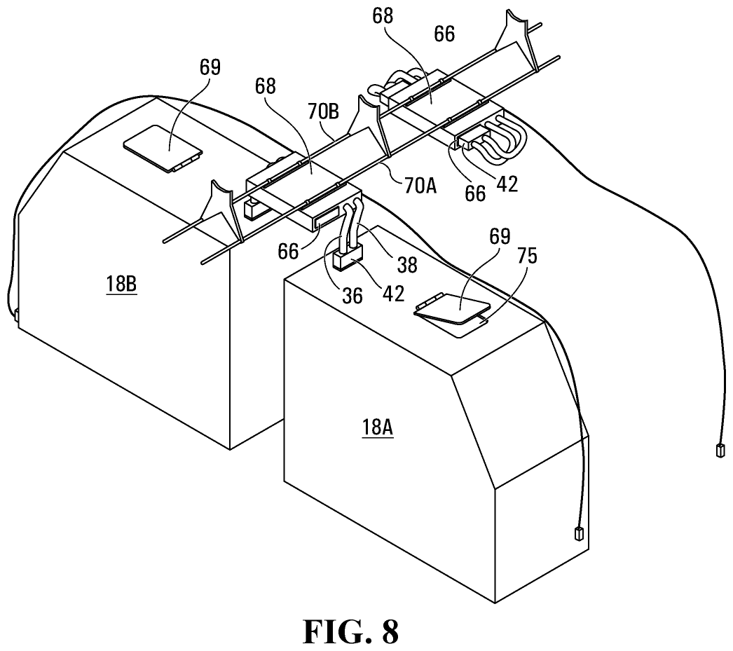

FIG. 8 shows a perspective view of a portion of cabin 12. Air circulation system 25 may be exterior to, and separable from, cargo container 18A and may be secured to a structure in cabin 12 that is configured to support one or more overhead bins. In the depicted embodiment, part of air circulation system 25 that includes circulation fan 32, smoke detector 16, overpressure valve 44, equalization valve 46 and third conduit 40 may be disposed within housing 68. Housing 68 may be a metal enclosure. First conduit 36 and second conduit 38 may each extend out of a respective opening defined in housing 68. Housing 68 may include storage connection 66 for storing receptacle 42 when not in use. Receptacle 42 may be coupled to storage connection 66 of housing 68 when receptacle 42 is not coupled to cargo container 18A. In some embodiments, receptacle 42 may be secured to housing 68 using any releasable coupling mechanism and/or fastening means, including a quick-connect/disconnect fitting. In an example, receptacle 42 may be secured to housing 68 with a magnet on one or both of receptacle 42 and housing 68. In another example, releasable coupling mechanism and/or fastening means may be clips, fasteners, sliding fasteners, snap-fit fasteners, clamp, etc. In another example, storage connection 66 may be a recess and receptacle 42 is configured to couple storage connection 66 by pressure fitting into the recess. However, it should be understood that receptacle 42 may be secured to the housing using any suitable coupling means. Housing 68 may be secured to one or more brackets 70A, 70B that are may be used for supporting one or more overhead bins or are specifically installed to mount housing 68. As depicted, a top surface of housing 68 may be clipped to brackets 70A, 70B. It should be understood that housing 68 may be secured to brackets 70A, 70B using any suitable fastening means. When receptacle 42 is disconnected from a cargo container and secured to storage connection 66, receptacle 42 is in a stowed position as depicted in FIG. 7 in which receptacle 42 is in a fixed position to not move during flight. When receptacles 42 is in a stowed position, a closed loop flow path may be defined by first conduit 36, second conduit 38, third conduit 40, circulation fan 32, smoke detector 16, receptacle 42, overpressure valve 44, equalization valve 46, and storage connection 66. In an embodiment, cargo container 18A, 18B may comprise a dedicated decompression panel 69 separate from air circulation system 25. Similar to decompression panel 58, decompression panel 69 may be movable between a closed position and an opened position. As depicted in FIG. 8, decompression panel 69 is illustrated as part of cargo containers 18A, 18B each covering opening 75 defined by cargo container 18A, 18B. Decompression panel 69 may be biased to a closed position. When decompression panel 69 is in a closed position, which is illustrated on cargo container 18B of FIG. 8, decompression panel 69 may be positioned to cover opening 75 defined in cargo container 18A, 18B to prevent air from being vented from the internal volume defined by cargo container 18A, 18B to cabin 12. When decompression panel 69 is in an open position, which is illustrated in FIG. 8 on cargo container 18A, decompression panel 69 may opening 75 to permit air to be vented from the internal volume defined by cargo container 18A to cabin 12 thereby decreasing pressure in cargo container 18A. Decompression panel 69 may operate as a pressure safety valve to prevent rupture of cargo container 18A. Decompression panel 69 may be set to open in the same manner as decompression panel 58 described above such that decompression panel 69 may be configured to transition from the closed position to the opened position when a pressure within cargo container 18A, 18B is greater than specified pressure above a pressure within cabin 12. For example, decompression panel 69 may be set to open when pressure within cargo container is greater than a pressure within cabin 12 by 14 kPa. In some embodiments, air circulation system 25, 125 may be free of a decompression panel, and cargo container 18A, 18B may comprise decompression panel 69 to provide a pressure safety valve for the cargo container.

FIG. 9 shows a perspective view of an air circulation system 125. Air circulation system 125 is an similar to air circulation system 25 has many of the same elements as air circulation system 25 described above with respect FIG. 5 and those element references are illustrated by adding one hundred to the element number. Air circulation system 125 may comprise a circulation fan 132, smoke detector 116, and receptacle 142; however, these elements are integrated within single housing 168 removing the need for conduits 36, 38, 40 shown in FIG. 5. Housing 168 is transparent in FIG. 5 to illustrate the internal component. Housing 168 may be aluminum or other suitable material such as corrosion resistant steel to resist corrosion and/or degradation due to temperature. Closed loop flow path 129 may comprise a first portion 129A of closed loop flow path 129 that circulates air through cargo container 118. The first portion of the closed loop flow path may be external to the internal volume of the cargo container. Only a portion of cargo container 118 is illustrated in stippled lines to show a bottom portion of housing 168. Flow path 129 may also comprise a second portion 129B of closed loop flow path 129 defined by smoke detector 116, temperature sensor 117, circulation fan 132, and openings 176, 178, which are shown as an outlet and inlet respectively. Circulation fan 132 may be configured to receive power via one or more electrical lines 50, and may circulate air from cargo container 118 to smoke detector 116 and/or temperature sensor 117 via closed loop flow path 129. One or more fan sensors 19, which may be incorporated in circulation fan 132, may be configured to transmit data indicative of a rotational speed of a rotor of circulation fan 32 to controller 20 using one or more electrical lines 50. In an embodiment, closed loop flow path may be free of a circulation fan 132, and smoke detector 116 may be an ambient-area smoke detector. In this embodiment, heat and/or smoke may rise in container 18A toward air circulation system 125 and ambient-area smoke detector 116 naturally circulating air within container 18A for testing by smoke detector 116. As shown in FIG. 10, receptacle 142 a smoke detector 116A that may be positioned within receptacle 142 such that second portion 129B of closed loop flow path 129 is defined by an interior chamber of receptacle 142, opening 161 defined by receptacle 142, and smoke detector 116A. Smoke detector 116, 116A may be configured to detect a presence of smoke within the air circulated through the internal volume defined by cargo container 18A. Smoke detector 116, 116A, and/or temperature sensor 117 may be configured to receive air directly from cargo container 18A as air circulation system 125 including housing 168 is coupled directly to cargo container 18A to fluidly communicate interior chamber of housing 168 with the inside of cargo container 18A through opening 161. In an embodiment, smoke detector 116A may extend through opening 161 into cargo container 18A when housing 168 is coupled to the cargo container.

Overpressure valve 144 may be disposed on housing 168 in fluid communication with opening 161 and the interior of cargo contain 18A when housing 168 and receptacle 142 are couple to container 18A. Overpressure valve 144 may be a pressure-control valve that is configurable between an opened and closed position. Similar to air circulation system 25 shown in FIG. 5, overpressure valve 144 may be opened to vent some air in closed loop flow path 129 to a location exterior to cabin 12 when the air pressure within closed loop flow path 129 exceeds a prescribed pressure. When overpressure valve 144 is opened, some air in closed loop flow path 129 may be received in bypass duct 45 that directs air to a location underneath cabin 12. In some embodiments, the air may be directed to an ambient environment via an exhaust system of aircraft 10.

Equalization valve 146 may be a pressure-control valve that is configurable between an opened and closed position. As aircraft 10 ascends or descents, pressure inside cabin 12 will decrease or increase respectively. Avoid material fatigue and/or rupture of cargo containers, equalization valve 146 may open to equalize the pressure between the closed loop flow path 129 (and the interior of cargo container 18A) and the exterior of cargo container 18A. Equalization valve 146 may be opened to allow air to be received in closed loop flow path 129 from cabin 12 when the air pressure within closed loop flow path 29 is less than the prescribed pressure to open overpressure valve 144.

Receptacle 142 may be coupled to a surface of cargo container 18A and may be configured to secure port 72 of first conduit 36 and port 74 of second conduit 38 to the surface of cargo container 18A such that openings 176, 178 are in fluid communication in the interior of cargo container 18A. In some embodiments, receptacle 142 may have receptacle sensors 121 incorporated into receptacle 142. As shown in FIG. 10, a plurality of sensors 121 may be positioned on a surface of receptacle 142 to sense if receptacle 142 has been positioned in a described position of cargo container 18A. Receptacle sensors 21 may be configured to receive power via one or more electrical lines 52. Receptacle sensors 121 may be configured to transmit data indicating if the internal volume defined by cargo container 18A is fluidly connected to first portion 129A of closed loop flow path 129 to controller 20 using one or more electrical lines 52.

Receptacle 142 may include pressure valve comprising a decompression panel 158 that is movable between a closed position and an opened position. As depicted in FIG. 9, decompression panel 158 is biased to a closed position. Receptacle 142 defines opening 61 which may be configured to overlap with third opening 63 defined in cargo container. When decompression panel 58 is in a closed position, decompression panel 58 may be positioned to cover third opening 63 defined in cargo container 18A to prevent air from being vented from the internal volume defined by cargo container 18A to cabin 12. When decompression panel 58 is in an opened position, decompression panel 58 may expose third opening 63 to permit air to be vented from the internal volume defined by cargo container 18A to cabin 12 thereby decreasing pressure in cargo container 18A. Decompression panel 158 may operate as a pressure safety valve to prevent rupture of cargo container 18A.

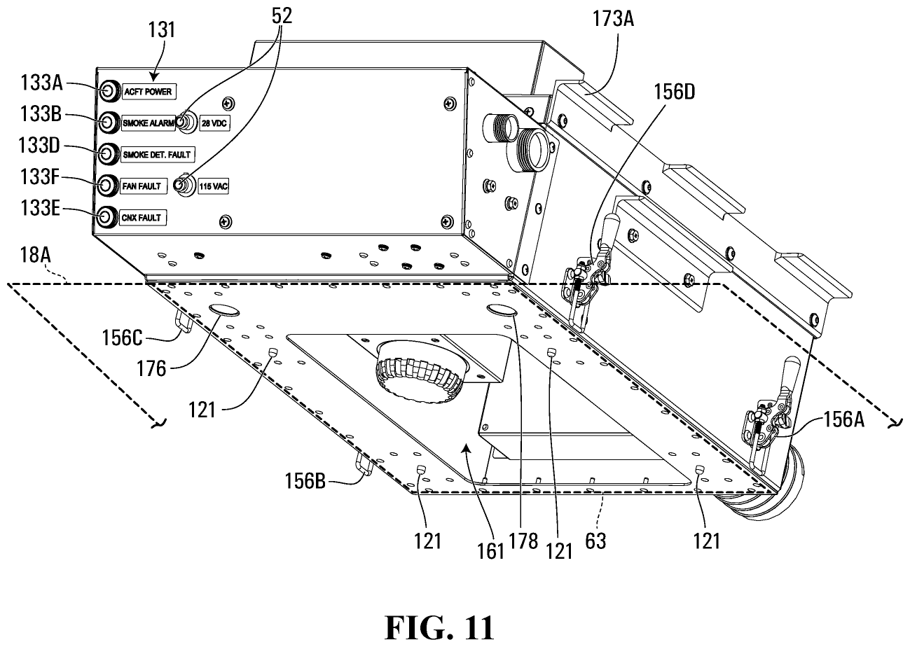

Similar to the embodiment illustrated in FIG. 5, in some embodiments, cargo container 18A may have mounting surface 54 on the surface of cargo container 18, e.g. a mounting plate. Receptacle 142 may be coupled to mounting surface 54 with a releasable coupling mechanism. As shown in FIGS. 9, 10, and 11 releasable coupling mechanism may be clips 156A 156B, 156C, and 156D of receptacle 142 used to couple receptacle 142 onto members 54B of mounting surface 54. As described above with respect to FIGS. 6A and 6B, mounting surface 54 may comprise alignment members 54A such as rails and/or grooves to align receptacle 142 on the mounting surface such that opening 63 of cargo container is sealably covered by receptacle 142. As depicted, clips 156A-D may clip onto opposite ends of mounting plate 54. It should be understood that other releasable coupling mechanism may be used to secure receptacle 142 to the surface of cargo container 18A.

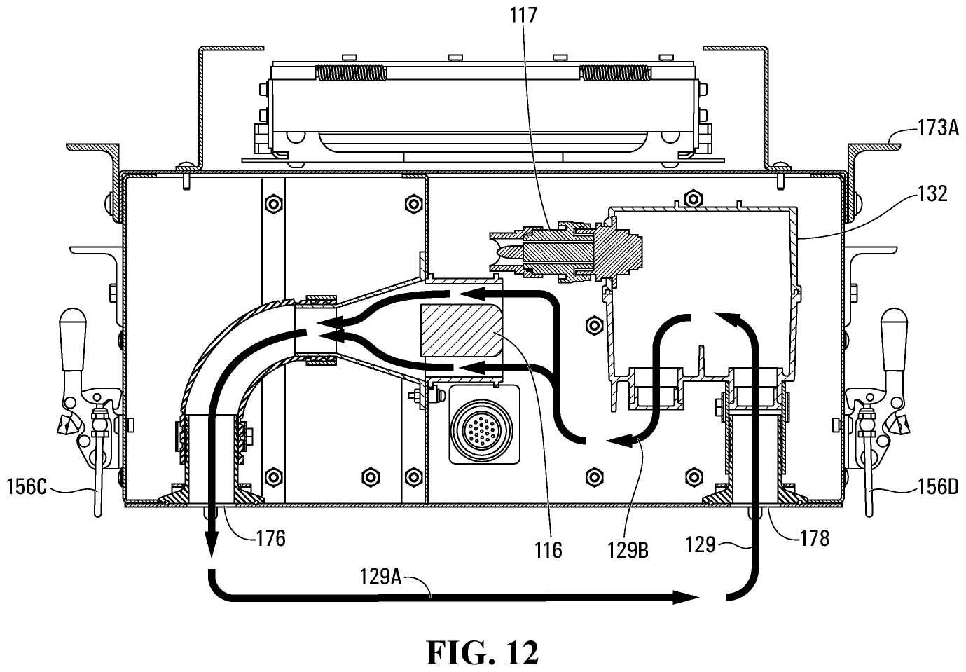

FIG. 12 illustrates a cross-sectional view along line 12-12 of FIG. 10. As shown closed loop flow path 129 may have a first portion 129A defined by the air circulation system 125, the closed loop flow path having a second portion 129B that passes through an internal volume defined by the cargo container 118. Closed loop flow path 129 may comprise a first portion 129A of closed loop flow path 129 that circulates air through cargo container 118. The first portion of the closed loop flow path may be external to the internal volume of the cargo container. Flow path 129 may also comprise a second portion 129B of closed loop flow path 129 defined by smoke detector 116, and/or temperature sensor 117, and optionally circulation fan 132, and openings 176, 178, which are shown as an outlet and inlet respectively. Circulation fan 132 may be configured to receive power via one or more electrical lines 50, and may circulate air from cargo container 118 to smoke detector 116 and/or temperature sensor 117 via closed loop flow path 129. As shown, air circulation system 125 is separate and/or exterior to the cargo container.

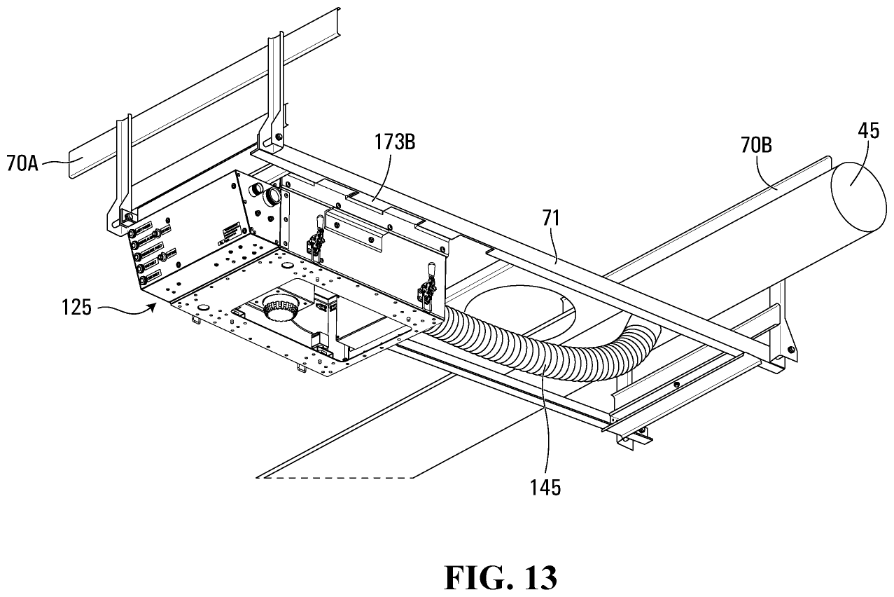

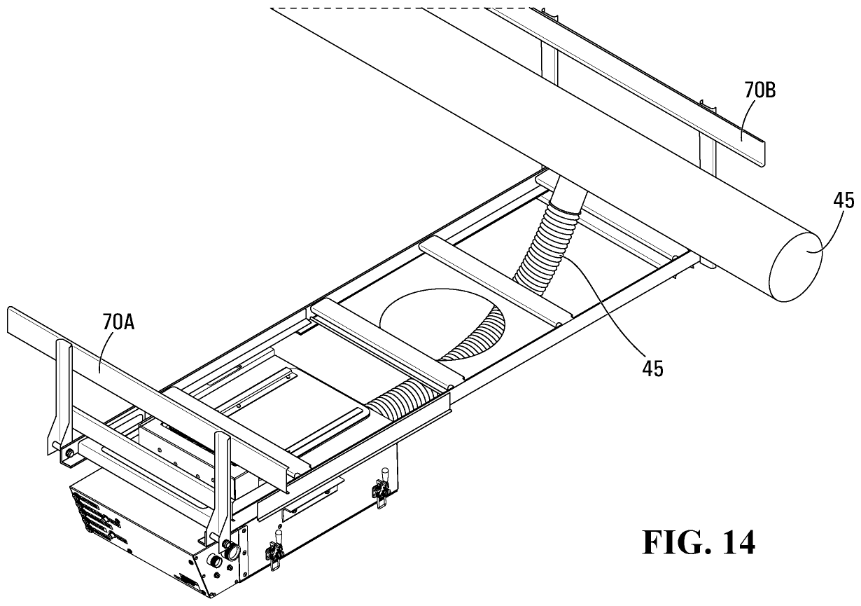

FIG. 13 illustrates a bottom perspective view of air circulation system 125 in a stowed position. Air circulation system 125 may be exterior to, and separable from, cargo container 18 and may be secured to a structure in cabin 12 that is configured to support one or more overhead bins. In some embodiments, air circulation system 125 may be secured to mount 71. As shown in FIGS. 13 and 14, coupling member 173A positioned on an exterior of housing may slidably engage to a counterpart coupling member 173B on mount 71 to secure air circulation system 125 for stowage. Coupling members 173A, 173B may be any releasable coupling mechanism, including a quick-connect/disconnect fitting. In an example, air circulation system 125 may be secured to mount 71 with a magnet on one or both of. In another example, releasable coupling mechanism may be clips, fasteners, sliding fasteners, snap-fit fasteners, clamp, etc. Mount 71 may be secured to one or more brackets 70A, 70B that are may be used for supporting one or more overhead bins or are specifically installed to mount housing 68. When air circulation system 125 is disconnected from a cargo container and secured to mount 71, air circulation system 125 is in a stowed position as depicted in FIGS. 13 and 14 in which air circulation system 125 is in a fixed position to not move during flight.

### Alternate Embodiments

The above description is meant to be exemplary only, and one skilled in the relevant arts will recognize that changes may be made to the embodiments described without departing from the scope of the invention disclosed. The present disclosure may be embodied in other specific forms without departing from the subject matter of the claims. The present disclosure is intended to cover and embrace all suitable changes in technology. Modifications which fall within the scope of the present invention will be apparent to those skilled in the art, in light of a review of this disclosure, and such modifications are intended to fall within the appended claims. Also, the scope of the claims should not be limited by the preferred embodiments set forth in the examples, but should be given the broadest interpretation consistent with the description as a whole.

As can be understood, the detailed embodiments described above and illustrated are intended to be examples only. The invention is defined by the appended claims.

The claims are not intended to include, and should not be interpreted to include, means-plus- or step-plus-function limitations, unless such a limitation is explicitly recited in a given claim using the phrase(s) “means for” or “step for,” respectively.

1. A system comprising:
a housing having an interface for coupling to a mounting surface of a cargo container in an aircraft cabin, the interface comprising a first surface configured to releasably couple and seal to a mounting surface of the cargo container defining an opening;
a releasable coupling mechanism for coupling the housing to the mounting surface of the cargo container;
a sensor configured to detect at least one of a concentration of smoke or temperature within an internal volume defined by the cargo container, the smoke detector being disposed to fluidly communicate with the internal volume through the opening when the housing is coupled to the mounting surface of the cargo container; and
a controller configured to:
receive data from the sensor indicative of the at least one of the concentration of smoke or temperature; and
when the at least one of the concentration of smoke or temperature exceed a prescribed value, generate a output for communicating a first alert.

2. The system of claim 1, wherein the housing defines a first portion of a closed loop flow path, wherein when the interface of the housing is coupled to the mounting surface of the cargo container, internal volume of the cargo container defines a second portion of the closed loop flow path; and where the sensor being disposed along the first portion of the closed loop flow path, optionally the system comprising a circulation fan configured to circulate air from the internal volume to the sensor.

3. (canceled)

4. The system of claim 1, wherein:
the housing comprises a decompression panel that is configurable between a closed position and an opened position;
when the decompression panel is in the closed position, the housing and the decompression panel cover the opening defined by the cargo container preventing air from venting from the internal volume of the cargo container;
when the decompression panel is in the opened position, the decompression panel is configured to expose the opening to the cabin to vent air within the cargo container to the cabin;
the decompression panel is configured to transition from the closed position to the opened position when a pressure within the cargo container exceeds a pressure within the cabin by a prescribed amount.

5. The system of claim 1, wherein the mounting surface is a mounting plate, and wherein the housing comprises the releasable coupling mechanism to couple to the mounting plate, wherein the releasable coupling mechanism comprises at least one of hook and clip configured to couple with the mounting plate; a magnet configured to releasably couple the interface to the mounting plate; a screw fastener for releasably coupling the interface to the mounting plate; a sliding fastener; a snap-fit fastener; and a clamp.

6. (canceled)

7. (canceled)

8. The system of claim 1, comprising a overpressure control valve that is configured to vent air in the internal volume to a location exterior to the cabin when a pressure within the cargo container exceeds a prescribed pressure.

9. The system of claim 1, wherein the housing comprises an equalization valve configured to open allowing fluid communication between the cabin and the internal volume when a pressure within the cargo container is less than a second prescribed pressure and close when the pressure within the cargo container is greater than or equal to the second prescribed pressure.

10. The system of claim 1, wherein the interface comprises a plurality of receptacle sensors configured to signal the controller when the receptacle sensors are positioned on the mounting surface, wherein upon receipt of the signal from the receptacle sensor the controller generates a output for communicating a second alert.

11. The system of claim 1, wherein the housing comprising a mounting member configured to couple to one or more brackets of the cabin for supporting one or more overhead bins, wherein the mounting member is configured to secured the housing when stowed.

12. (canceled)

13. A system for detecting smoke or a temperature in one or more cargo containers in a cabin of an aircraft, the system comprising:
an air circulation system defining a first portion of a closed loop flow path, when the air circulation system is coupled to a mounting surface of one of the one or more cargo containers, the internal volume of the one cargo container defines a second portion of the closed loop flow path; and
a smoke detector configured to detect a presence of at least one of smoke or temperature within air circulated through the internal volume defined by the cargo container, the smoke detector being disposed along the first portion of the closed loop flow path;
wherein the system is exterior to the cargo container.

14. (canceled)

15. The system of claim 13, comprising one or more conduits defining the first portion of the closed loop flow path, wherein:
the one or more conduits includes a first conduit and a second conduit;
the first conduit is configured to supply air to the internal volume of the cargo container through an first opening defined in the cargo container; and
the second conduit is configured to receive air from the internal volume of the cargo container through a second opening defined in the cargo container.

16. (canceled)

17. (canceled)

18. (canceled)

19. The system of claim 13, wherein the air circulation system comprises:
a receptacle having an interface that is configured for coupling to a mounting surface of the cargo container defining a third opening;
wherein the interface is configured to sealably couple to the mounting surface of the cargo container such that smoke detector is in fluid communication with the internal volume of the cargo container.

20. The system of claim 19, wherein:
the receptacle comprises a decompression panel that is configurable between a closed position and an opened position;
when the decompression panel is in the closed position, the receptacle and decompression panel cover the third opening defined by the cargo container and prevent air from venting from the internal volume of the cargo container;
when the decompression panel is in the opened position, the decompression panel is configured to expose the third opening to the cabin to vent air within the cargo container to the cabin;
the decompression panel is configured to transition from the closed position to the opened position when a pressure within the cargo container exceeds a pressure within the cabin by a prescribed amount.

21. The system of claim 19, wherein the mounting surface is a mounting plate, and wherein the receptacle comprises a releasable coupling mechanism to couple to the mounting plate.

22. The system of claim 13, comprising a fire expellant system having:
a reservoir for fire expellant;
a conduit coupling the reservoir to the air circulation system;
a valve to control the flow of fire expellant from the reservoir to the air circulation system, the conduit fluidly communicating with the air circulation system and the internal volume of the cargo container when the valve is in an open position.

23. The system of claim 13, comprises a controller configured to:
receive data indicative of at least one of a concentration of smoke and/or temperature, within the air circulated through the internal volume defined by the cargo container from the smoke detector;
receive data indicative of the position of the cargo container within the aircraft;
determine that at least one of the concentration of smoke and/or temperature within the air exceeds a prescribed value; and
when the at least one of the concentration of smoke and/or temperature exceed the prescribed value, generate an output configured to cause an indicator to be activated associated with the position of the cargo container in the aircraft.

24. The system of claim 23, comprises one or more sensors for determining a status of the one or more cargo containers within the cabin of the aircraft and wherein the controller is configured to receive data from the sensors indicative of the status of at least one of:
deployment of a fire expellant to the cargo container;
operational status of the smoke detector;
one of the one or more air circulation system coupling to the cargo container; and
a fan speed of the circulation fan below a prescribed value;
and wherein the controller is configured to generate an output to cause an indicator to be activated associated with the status and the position of the cargo container in the aircraft,
wherein the controller is configured to receive data from a switch to deploy fire expellant to one of the cargo containers, and to generate a signal to open a valve controlling flow of fire expellant from a reservoir to the cargo container.

25. (canceled)

26. A system for detecting the presence of smoke in each of a plurality of cargo containers stored in a cabin of an aircraft, the system comprising:
a controller configured to:
receive data indicative of at least one of a concentration of smoke and/or temperature within the air circulated through each internal volume defined by each cargo container from a smoke detector;
receive data indicative of the position of the cargo container within the aircraft;
determine that the at least one of the concentration of smoke and/or temperature within the air exceeds a prescribed value; and
when the at least one of the concentration of smoke and/or temperature exceed the prescribed value, generate a first output for communicating an alert.

27. (canceled)

28. The system of claim 26, wherein the controller is configured to receive data from one or more sensors indicative of the status of at least one of:
deployment of a fire expellant to the cargo container;
operational status of the smoke detector;
receptacle coupling to the cargo container; and
a fan speed of the circulation fan below a prescribed value; and
wherein the controller is configured to generate an output to cause an indicator to be activated associated with the status and with the position of the cargo container in the aircraft.

29. A cargo container for coupling to the housing of claim 1 or the air circulation system of claim 13, the cargo container comprising:
a cargo container housing comprising a mounting surface defining an opening to fluidly communicate an internal volume of the cargo container to the housing of claim 1 or the air circulation system of claim 13, the mounting surface configured to releasably and sealably couple to the system with a releasable coupling mechanism.

30. (canceled)

31. (canceled)

32. The cargo container of claim 29, wherein the releasable coupling mechanism comprise at least one of hook and clip; a magnet; a screw fastener; a sliding fastener; a snap-fit fastener; and a clamp.

33. The cargo container of claim 29, the cargo container comprises a decompression panel that is configurable between a closed position and an opened position; wherein:
when the decompression panel is in the closed position, the decompression panel covers a second opening defined by the cargo container and prevents air from venting from the internal volume of the cargo container;
when the decompression panel is in the opened position, the decompression panel is configured to expose the second opening to the cabin to vent air within the cargo container to the cabin;
the decompression panel is configured to transition from the closed position to the opened position when a pressure within the cargo container exceeds a pressure within the cabin by a prescribed amount.
